(19) United States
(12) Patent Application Publication
(10) Pub. No.: US 2016/0092070 A1
(43) Pub. Date: Mar. 31, 2016

(54) LOCATION DISPLAY METHOD, PORTABLE COMMUNICATION APPARATUS USING THE METHOD AND RECORDING MEDIUM USING THE METHOD

(71) Applicant: HTC Corporation, Taoyuan County (TW)

(72) Inventors: Kuo-Tien Chen, Taoyuan County (TW); Hsin-Hao Lee, Taoyuan County (TW); Chia-Lin Chang, Taoyuan County (TW); Chun-Hsiang Wang, Taoyuan County (TW)

(21) Appl. No.: 14/501,051

(22) Filed: Sep. 30, 2014

(51) Int. Cl. G06F 3/0481; G06F 3/0488; H04W 4/04; G06F 3/0484

(52) U.S. Cl. CPC G06F 3/04817; G06F 3/04842; G06F 3/04886; H04W 4/04

(57) ABSTRACT

A location display method, a portable communication apparatus using the method, and a recording medium using the method are provided. The method is adapted for the portable communication apparatus having a positioning unit and a touch screen. In the method, the portable communication apparatus is positioned to obtain first location information by using the positioning unit. Next, a communication interface is displayed on the touch screen to proceed a call, in which the communication interface displays the first location information. Furthermore, a location sharing key may also be displayed in the communication interface, and a selecting operation performed on the location sharing key is received by using the touch screen, and according to contact information of an opposite party of the call, the first location information is sent to the opposite party and/or second location information sent by the opposite party is received.

### BACKGROUND

With the continuous advancement and improvement of electronic technology and communication techniques, various portable apparatuses such as a smart phone, a personal digital assistant (PDA), and a tablet PC are also evolving rapidly. The portable apparatus in the market now are integrated with a greater number of functions to increase their competitiveness. In addition to the conventional functions of taking photos, calling, and surfing the Internet, a global positioning system (GPS), an electronic map, and a navigation system are also integrated into the portable apparatuses nowadays. Hence, a user can monitor her/his location through the electronic map at anytime, anywhere. Also, by the planning and guiding of the navigation system, the best route can be determined in order to reach the destination more quickly and safely.

However, so far, despite the growing popularity of portable electronic apparatuses equipped with the GPS, functionality and convenience thereof are still imperfect. Particularly, for a portable communication apparatus with a calling function (e.g., the smart phone), a positioning system in a system of the smart phone has not been able to fully cooperate with advantages in portable communication for developing a usage mechanism that is intuitive and user-friendly.

### SUMMARY

In a general calling situation, a user of a communication apparatus often need to inform an opposite party of a current location, a landmark nearby or other geographic information. In this case, the user must interrupt the call before she/he can use a positioning system in the communication apparatus for positioning and searching, and then re-call to inform the opposite party of the result, which is very inconvenience. Worse yet, if the user is unfamiliar with the current location, or the user has trouble in reading maps and a poor sense of direction, it may take a great amount of time to read the map. Even if the current location is eventually found, directions, relative location between roads and landmarks informed to the opposite party may still be wrong, such that the opposite party may misjudge the current direction of the user.

The present application provides a location display method, a portable communication apparatus using the method, and a recording medium using the method, which are capable of instantly displaying and sharing locations in proceeding of a call.

The location display method of the present application is adapted for the portable communication apparatus having a positioning unit and a touch screen. In the method, the portable communication apparatus is positioned to obtain first location information by using the positioning unit. Next, a communication interface is displayed on the touch screen to proceed a call, in which the communication interface displays the first location information.

In an example of the present application, the method further includes displaying a location sharing key; and receiving a selecting operation performed on the location sharing key by using the touch screen, and according to contact information of an opposite party, sending the first location information to the opposite party and/or receiving second location information sent by the opposite party.

In an example of the present application, the step of displaying the communication interface on the touch screen to proceed the call further includes detecting whether there is an object nearby by using a sensor; if the object is detected, disabling a touch function of the touch screen; and if the object is not detected, activating the touch screen to display communication interface.

In an example of the present application, the method further includes searching points of interest located near the first location information, and displaying at least one of the points of interest in the communication interface.

In an example of the present application, the step of displaying the communication interface on the touch screen to proceed the call includes displaying a dialing keyboard having a plurality of keys in the communication interface; and receiving the selection operation performed on the keys by using the touch screen, and searching at least one corresponding contact according to the keys selected by the selection operation and a sequence thereof.

In an example of the present application, the method further includes receiving the second location information sent by an opposite party, and displaying one of the second location information and relative location information between the first location information and the second location information or a combination thereof in the communication interface.

In an example of the present application, the method further includes displaying an electronic map in the communication interface, and marking the first location information and the second location information on the electronic map.

In an example of the present application, the method further includes displaying an image of the opposite party in the communication interface; and receiving a switch operation performed on the image by using the touch screen, displaying an electronic map around the first location information as a replacement to the image, and marking the first location information on the electronic map.

In an example of the present application, the method further includes displaying an elapsed time after positioning the portable communication apparatus and obtaining the first location information by the positioning unit in the communication interface.

A portable communication apparatus of the present application includes a wireless communication unit, a positioning unit, a touch screen, a storage unit and one or more processing units. The positioning unit is configured to position the portable communication apparatus to obtain first location information. The storage unit is configured to record a plurality of modules. The processing unit is connected to the first wireless communication unit, the positioning unit, the touch screen and the storage unit, and configured to access and execute the modules recorded in the storage unit. The modules include a positioning module, a call module, and a location sharing module. The positioning module positions the portable communication apparatus to obtain the first location information by using the positioning unit. The call module displays a communication interface on the touch screen to proceed a call by using the wireless communication unit, in which the communication interface includes displaying the first location information.

In an example of the present application, the call module further displays a location sharing key in the communication interface, and the modules further include a location sharing module, which sends the first location information to the opposite party and/or receives second location information sent by the opposite party according to contact information of an opposite party when a selecting operation performed on the location sharing key is received by the touch screen.

In an example of the present application, the portable communication apparatus further includes a sensor, which is configured to detect whether there is an object nearby. The call module disables a touch function of the touch screen if the object is detected by the sensor, and the call module activates the touch screen to display the communication interface if the object is not detected by the sensor.

In an example of the present application, the call module further displays a point of interest key in the communication interface, and the modules further include a point of interest searching module, which searches points of interest located near the first location information, and displays at least one searched point of interest in the communication interface by the call module when the selecting operation performed on the point of interest key is received by the touch screen.

In an example of the present application, the call module further displays a dialing keyboard having a plurality of keys in the communication interface, and searches at least one corresponding contact according to the keys selected by the selection operation and a sequence thereof when the selection operation performed on the keys is received by the touch screen.

In an example of the present application, the call module further displays a location interconnection key in the communication interface, and the modules further include a location interconnection module, which receives the second location information sent by an opposite party, and displays one of the second location information and relative location information between the first location information and the second location information or a combination thereof in the communication interface when the selecting operation performed on the location interconnection key is received by the touch screen.

In an example of the present application, the call module further displays a map displaying key in the communication interface, and the modules further include a map displaying module, which displays an electronic map in the communication interface, and marks the first location information and the second location information on the electronic map when the selecting operation performed on the map displaying key is received by the touch screen.

In an example of the present application, the location interconnection module further re-positions the portable communication apparatus by using the positioning unit per a time interval to update the first location information where the portable communication apparatus is located, and receives the updated second location information sent by the opposite party thereby updating one of the first location information, the second location information and the relative location information thereof or a combination thereof being displayed.

In an example of the present application, the call module further displays an image of the opposite party in the communication interface, and the modules further include a map displaying module, which displays an electronic map around the first location information as a replacement to the image, and marks the first location information on the electronic map when a switch operation performed on the image is received by the touch screen.

In an example of the present application, the call module further displays an elapsed time after positioning the portable communication apparatus and obtaining the first location information by the positioning unit in the communication interface.

The present application further provides a non-transitory recording medium in which a computer program is recorded. The computer program is loaded by a portable communication apparatus to execute the following steps. First of all, the portable communication apparatus is positioned to obtain first location information by using a positioning unit. Next, a communication interface is displayed on the touch screen to proceed a call, in which the communication interface displays the first location information.

Based on the above, the location display method, the portable communication apparatus using the method and the recording medium using the method according to the present application are capable of displaying the location of the portable communication apparatus in the communication interface, and providing the location display method for the user to select for sharing the location information with the opposite party. Accordingly, the user is able to learn the location of the opposite party and the relative location between each other during the call, so that the user may find the opposite party more easily.

To make the above features and advantages of the present application more comprehensible, several examples accompanied with drawings are described in detail as follows.

### BRIEF DESCRIPTION OF THE DRAWINGS

FIG. 1 is a block diagram illustrating a portable communication apparatus according to an example of the present application.

FIG. 2 is a flowchart illustrating a location display method according to an example of the present application.

FIG. 3A to FIG. 3C illustrate an example of the location display method according to an example of the present application.

FIG. 4 is a flowchart illustrating a location display method according to an example of the present application.

FIG. 5A to FIG. 5D illustrate an example of the location display method according to an example of the present application.

### DESCRIPTION OF THE EXAMPLES

The present application is capable of identifying an opposite party called by a user in proceeding of a call. Once an identity of the opposite party is confirmed, location information may be exchanged between the opposite party and the user. The location information may be displayed in a communication interface for the user to monitor locations of the user and the opposite party during the call, so as to further assist the user and the opposite party in finding each other. In addition, the present application further provides functions such as points of interest searching, map displaying, so as to assist the user in quickly monitoring her/his current location and sharing the same to the opposite party.

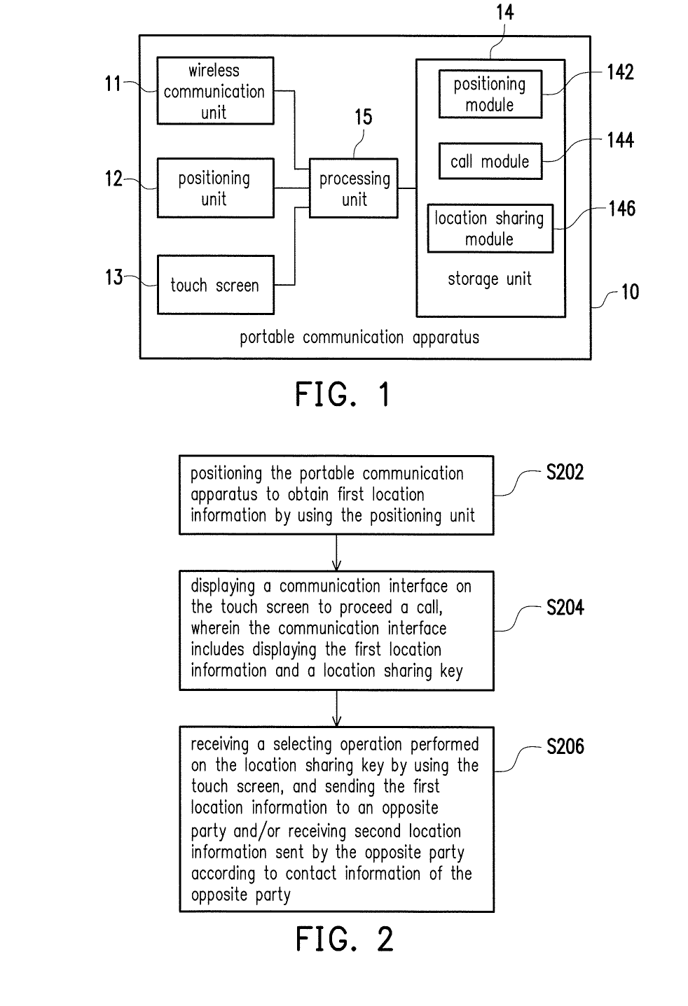

FIG. 1 is a block diagram illustrating a portable communication apparatus according to an example of the present application. Referring to FIG. 1, a portable communication apparatus 10 of the present example includes a wireless communication unit 11, a positioning unit 12, a touch screen 13, a storage unit 14 and a processing unit 15. The portable communication apparatus 10 is, for example, an electronic apparatus capable of performing the calling function (e.g., a cell phone) or a car electronic apparatus, which are not particularly limited herein.

The wireless communication unit 11 is configured to communicate with other portable communication apparatuses, and capable of supporting at least one of the following technologies in wireless signal transmission: Global System for Mobile Communication (GSM) system, Personal Handy-phone System (PHS), Code Division Multiple Access (CDMA) system, Wireless fidelity (Wi-Fi) system, Worldwide Interoperability for Microwave Access (WiMAX) system, Radio Repeater or Radio Broadcaster, but the present application is not limited to the above.

The positioning unit 12 is configured to position the portable communication apparatus 10 in order to obtain current location information of the portable communication apparatus 10. The positioning unit 12 may be, for example, Global Positioning System (GPS), a system that performs a positioning by using a cellular wireless communication base station, a system that performs a positioning by using WiFi hotspots, or other communication positioning systems that perform a positioning by using signals transmitted by said wireless communication unit 11, which are not particularly limited herein.

The touch screen 13 is, for example, formed by integrating touch detecting elements of resistance type, capacitive type, optical type or other types together with a liquid crystal display, and capable of detecting a touch operation from the user while displaying a frame of the portable communication apparatus 10.

The storage unit 14 may be a fixed or a movable device in any possible forms including a random access memory (RAM), a read-only memory (ROM), a flash memory or other similar devices, or a combination of the above-mentioned devices. In the present example, the storage unit 14 is configured to record a positioning module 142, a call module 144, and a location sharing module 146. The modules are, for example, programs stored in the storage unit 14 which can be loaded by the processing unit 15 of the portable communication apparatus 10, so that the processing unit 15 may execute functions of location display.

The processing unit 15 is connected to the first wireless communication unit 11, the positioning unit 12, the touch screen 13 and the storage unit 14, respectively. The processing unit 15 may be a central processing unit (CPU) or other programmable devices for general purpose or special purpose such as a microprocessor, a digital signal processor (DSP), a programmable controller, an application specific integrated circuit (ASIC) or other similar elements or a combination of above-mentioned elements. In the present example, the processing unit 15 is configured to access and execute the modules recorded in the storage unit 14, so as to realize the location display method of the present application.

Specifically, FIG. 2 is a flowchart illustrating a location display method according to an example of the present application. Referring to FIG. 1 and FIG. 2 together, the method of the present example is adapted for aforesaid portable communication apparatus 10. Detailed steps in the method of the present example are described as below, with reference to each element of the portable communication apparatus 10 depicted in FIG. 1.

First of all, the positioning module 142 positions the portable communication apparatus 10 to obtain first location information by using the positioning unit 12 (step S202). The positioning module 142 starts to position the portable communication apparatus 10, for example, after the user activates a positioning function or activates the calling function.

Subsequently, the call module 144 displays a communication interface on the touch screen 13 for the user to proceed a call, and the communication interface displays, for example, the first location information of the portable communication apparatus 10 (step S204). Proceeding of the call may include times when dialing a call to an opposite party, dialing numbers or answering a call, as well as during the call, and thus the communication interface may include a communication interface for dialing the call to the opposite party, a communication interface for dialing the numbers or answering the call, and a communication interface during the call. In an example, the communication interface includes, for example, a dialing keyboard having a plurality of keys. The keys includes, for example, number keys (e.g., 0 to 9), symbol keys (e.g., #, *), and corresponding characters (e.g., English alphabets) may also be included on the number keys. The call module 144 receives a selection operation performed by the user on the keys by using the touch screen 13, and searches a corresponding contact according to the keys selected by the selection operation and a sequence of the keys selected by the selection operation so as to establish the call. The call module 144 searches, for example, the contact having a phone number matched to entered key information from an address book of the user and display the searched contact on the touch screen 13, such that the user is able to quickly select the opposite party to be called in order to establish the call. In another example, the call module 144 displays, for example, the communication interface including an answering key on the touch screen 13 after receiving an incoming call from the opposite party, and then receives a selecting operation performed by the user on the answering key by using the touch screen 13, so as to establish the call in between the user and the opposite party.

It should be noted that, the communication interfaces in different proceedings of the call may be displayed in different manners. For example, a location sharing key may only be displayed in the communication interface during the call but not displayed in the communication interface for dialing the call to the opposite party.

In an example, during the call, the call module 144 may, for example, further detect whether there is an object nearby (e.g., the human face or the human ear, etc.) the touch screen 13 by using one or more sensors (not illustrated) such as a proximity sensor or a light sensor disposed therein. When the object is detected by the sensor, the call module 144 disables a touch function of the touch screen 13, so as to prevent the touch screen 13 from being accidentally touched by the user; and when the object is not detected by the sensor (i.e., the object has moved away from the front of the touch screen 13), the call module 144 activates the touch screen 13 to display the communication interface. Accordingly, when the user is on the phone, the touch function of the touch screen 13 may be disabled to avoid accidental touch. When the user wishes to check her/his current location and moves the portable communication apparatus 10 away from the ear, the touch screen may be automatically activated to display the current location information of the user. In an example, the positioning module 142 may, for example, position the portable communication apparatus 10 again by using the positioning unit 12 when the call module 144 re-activates the calling function, so as to update the location information in the communication interface.

Lastly, the location sharing module 146 may detect the touch operation of the user by using the touch screen 13. When the selecting operation performed by the user on the location sharing key is received by the touch screen 13, the location sharing module 146 sends the first location information of the portable communication apparatus 10 to the opposite party and/or receives second location information sent by the opposite party according to contact information of the opposite party such as different location sharing permissions (step S206). The second location information is, for example, location information that is obtained after a positioning is performed by the opposite party, and an obtaining method thereof is identical or similar to that of the portable communication apparatus 10, which is not repeated hereinafter. Moreover, in another example, the location sharing module 146 may also control the portable communication apparatus 10 to exchange the location information with the opposite party, so that both the user and the opposite party are able to learn the current locations of each other.

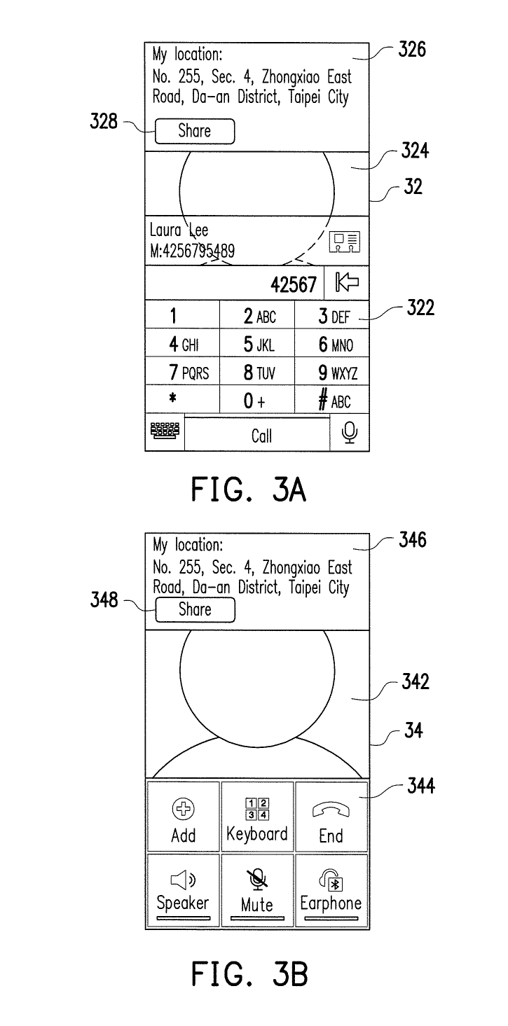

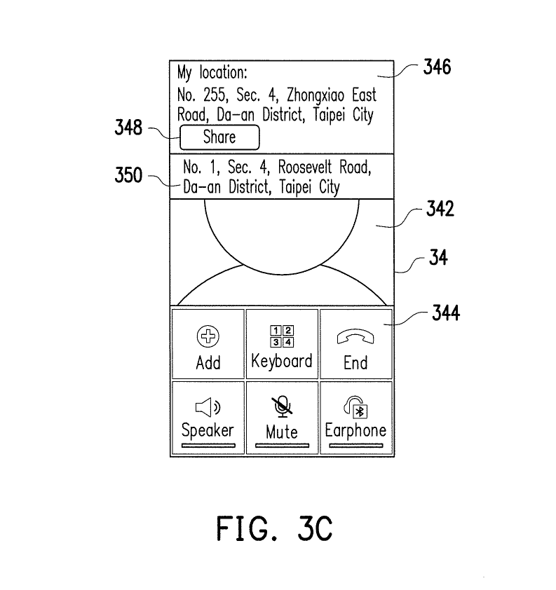

For instance, FIG. 3A to FIG. 3C illustrate an example of the location display method according to an example of the present application. Referring to FIG. 3A, during a process of establishing a call, the portable communication apparatus may, for example, display a communication interface 32 (in which a dialing keyboard 322 is included) on the touch screen for the user to dial numbers. When the user uses the dialing keyboard 322 to enter the numbers, the portable communication apparatus may then search the contact having a phone number matched to the entered numbers in an address book, and display contact information 324 (e.g., a name, an image and the phone number corresponding to the contact) of the searched contact in the communication interface 32. In addition, the portable communication apparatus may further obtain current location information 326 thereof and display the same on the top of the communication interface 32 for the user to learn her/his current location. The current location information 326 may be current location information obtained by the positioning module 142 performing a positioning after the calling function is activated by the user, or a latest current location information obtained by performing a positioning before the calling function is activated by the user. In an example, the portable communication apparatus further displays a location sharing key 328 in the communication interface 32 which can be selected by the user to share the location information 326 with the opposite party.

Subsequently, referring to FIG. 3B, when the portable communication apparatus has already established the call with the opposite party, the portable communication apparatus may display, for example, a communication interface 34 on the touch screen. The communication interface 34 may include an image 342 (e.g., a photo) of the opposite party and a plurality of calling function keys 344 (including “add call”, “keyboard”, “end call”, “speaker”, “mute” or “Bluetooth earphone”, etc.). In addition, the portable communication apparatus may further obtain current location information 346 where it is currently located (e.g., information such as address or coordinates of the current location information, nearest points of interest (POIs) including landmarks, shops, or buildings, or nearest road cross-section regarding the current location information) and display the same on the top of the communication interface 34 for the user to learn the current location. In an example, the portable communication apparatus may further display a location sharing key 348 in the communication interface 34 which can be selected by the user to share the location information 346 with the opposite party. When the user selects the location sharing key 348, the portable communication apparatus may, for example, send the current location information 346 to the opposite party while receiving location information 350 sent from the opposite party at the same time and displaying the same in the communication interface 34 (as shown in FIG. 3C). In another example, the location information sent to the opposite party may also be played in a voice manner, such that when the user is driving or calling in a speaker mode, the location information of the opposite party may be known without looking at the screen.

By using aforesaid methods, the portable communication apparatus 10 of the present example is capable of allowing the user to monitor the current location in proceeding of the call at anytime, and share the current location with the opposite party for both the user and the opposite party to find each other more quickly.

It is worth mentioning that, in another example, the portable communication apparatus is capable of allowing the user to set different location sharing permissions for different contacts. For example, settings regarding location sharing for a specific contact may be set in advance, and the location information may be regularly exchanged with the apparatuses of the specific contact, so as to track the location of the specific contact. The portable communication apparatus may determine whether a distance between itself and the specific contact is within a predetermined distance (e.g., 100 meters) according to the location information being exchanged. When the portable communication apparatus determines that the distance between itself and the specific contact is within the predetermined distance, a message may be sent to the apparatuses of the specific contact to inform the same to the specific contact; or the location information of the specific contact may be displayed on the touch screen to remind the user; or the user may be reminded that there is the contact currently within the predetermined distance in manners of displaying a prompt message, a prompt symbol or flashing light. By using aforesaid mechanisms of automatic tracking and reminding, the user is able to instantly obtain a location relation between the user and the contact, so as to monitor a status of the contact.

It should be noted that, in an example, in addition to the location sharing key, the portable communication apparatus may further display a location interconnection key in the communication interface. The location interconnection key may be provided for the user to select for viewing a relative location between the user and the opposite party. Another example is given for illustration below.

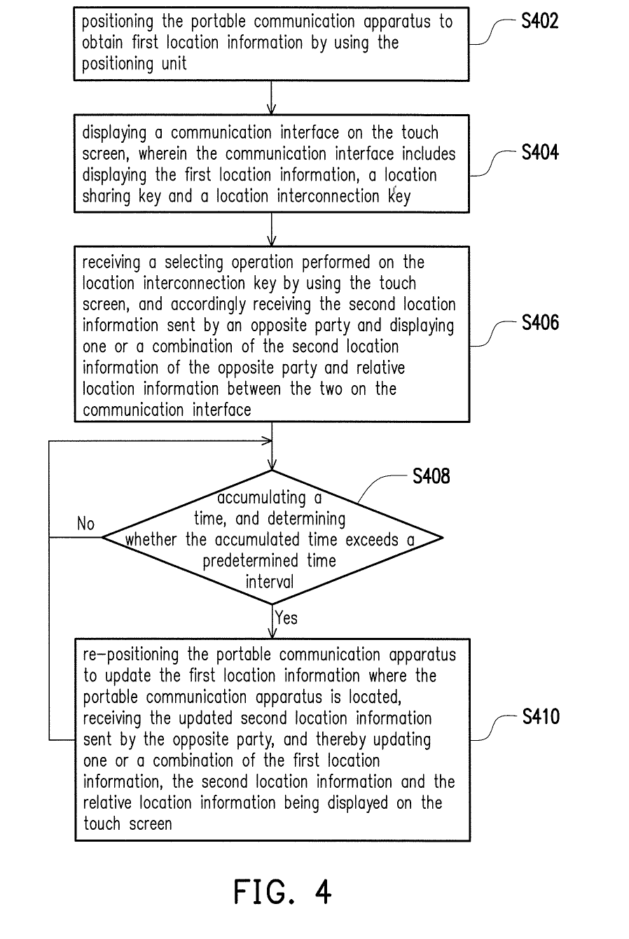

Specifically, FIG. 4 is a flowchart illustrating a location display method according to an example of the present application. Referring to FIG. 1 and FIG. 4 together, the method of the present example is adapted for aforesaid portable communication apparatus 10. Detailed steps in the method of the present example are described as below, with reference to each element of the portable communication apparatus 10 depicted in FIG. 1.

First of all, the positioning module 142 positions the portable communication apparatus 10 to obtain first location information by using the positioning unit 12 (step S402). The positioning module 142 starts to position the portable communication apparatus 10, for example, after the user activates the positioning function or activates the calling function. In an example, in the circumstances where the positioning function is not activated or the current location of the portable communication apparatus 10 is not re-positioned, a latest current location of the portable communication apparatus 10 being stored may also serve as the first location information.

Subsequently, the call module 144 displays a communication interface on the touch screen 13, and the communication interface includes, for example the first location information, a location sharing key and a location interconnection key of the portable communication apparatus 10 (step S404). The communication interface may display a dialing keyboard, a photo of the opposite party or display calling function keys including “add call”, “keyboard”, “end call”, “speaker”, “mute” and/or “Bluetooth earphone” according to the current calling conditions (e.g., during a call, dialing numbers by the user, dialing out a call, or answering an incoming call), and the displayed contents are identical or similar to those in the foregoing example, which are not repeated hereinafter. Unlike the foregoing example, in the present example, the call module 114 additionally displays a point of interest key and the location interconnection key in the communication interface. The point of interest key is provided for the user to select for searching the points of interest located near where the portable communication apparatus 10 is located and displaying the same in the communication interface (e.g., displaying a latest one or a fixed number of point of interest information). In addition, a type of the points of interest to be displayed may also be set in advance (e.g., set to display convenience stores, subway stations, subway station exits in higher priority), such that the user and the opposite party are able to identify locations of the points of interest more easily. The location interconnection key may be provided for the user to select for obtaining the relative location between the user and the opposite party.

Specifically, in the portable communication apparatus 10, a point of interest searching module (not illustrated) may receive the touch operation performed by the user on the communication interface by using the touch screen 13. When the touch screen 13 receives the selection operation performed by the user on the point of interest key, the point of interest searching module may search at least one of the points of interest located near the first location information and then the call module may display the searched points of interest in the communication interface. Aforesaid points of interest may be obtained by the point of interest searching module after searching a point of interest database built-in the portable communication apparatus 10, and/or obtained after searching a point of interest database on the Internet. The points of interest may be a cross-section, a station exit, an exit number of subway station, a name of a significant building, an entrance number of a mall, a department store, a parking lot, a shop, a convenience store nearest to the portable communication apparatus 10, which are not particularly limited herein. In another example, the point of interest information may also be directly displayed in the communication interface (e.g., the information of a nearest point of interest).

On the other hand, in the portable communication apparatus 10, a location interconnection module (not illustrated) may receive the touch operation performed by the user on the location interconnection key of the communication interface by using the touch screen 13. When the selecting operation performed by the user on the location interconnection key is received by the touch screen 13, the location interconnection module receives second location information sent by the opposite party through the wireless communication unit 11, and displays one or a combination of the second location information and relative location information between the two in the communication interface (step S406). The relative location information may include, for example, information such as a distance and/or a path between the first location information and the second location information. The distance may be a linear distance between the first location information and the second location information or a distance of the path, and the path may be a walking path, a biking path, a driving path or a public transportation path between the first and second location information, which are not particularly limited herein. In an example, a shortcut key may be displayed. After the shortcut key is selected by the user, path information or detailed path information may then be displayed. For example, the path information may be displayed in a map manner, or displayed in a text manner for displaying all routing lists. In another example, the second location information of the opposite party and/or the relative location information between the two may also be directly displayed in the communication interface. Moreover, in another example, in the circumstance that the user simultaneously calls more than two persons (e.g., a conference call, or calls to two or more persons respectively), the second location information of all the contacts being called may also be displayed simultaneously.

In an example, the location interconnection module may display said three information side by side in the communication interface, so that the user is able to learn a relative location relation between the user and the opposite party at a glance. In another example, the user may select which one of the three information is to be displayed in the communication interface. In yet another example, the location interconnection module may also display a map displaying key in the communication interface for the user to select for entering a map displaying mode. In this map displaying mode, the portable communication apparatus 10 may, for example, display an electronic map nearby on the touch screen 13 according to the first and/or second location information and mark the first and/or second location information on the electronic map by a map displaying module (not illustrated). A displaying method thereof may include displaying the first and second location information in the same window, or displaying the first and second location information in different windows, respectively. The method of displaying the information in the same window or the different windows may be decided according to the distance between the first and second location information, or may be decided by the user based on demands. Moreover, in another example, in the circumstance that the user simultaneously calls more than two persons (e.g., a conference call, or calls to the two or more persons respectively), the location information of all the contacts being called may also be displayed simultaneously.

It should be noted that, at the same time when displaying the first location information, the second location information and the relative location information, the location interconnection module may, for example, accumulate an elapsed time for displaying the information, and determine whether the accumulated time exceeds a predetermined time interval (step S408). The time interval may be 10 seconds, 30 seconds, 1 minute or other time length, which may be manually adjusted by the user based on practical demands.

In step S408, when the location interconnection module determines that the accumulated time does not exceed the predetermined time interval, the time will be accumulated continuously. When the location interconnection module determines that the accumulated time exceeds the predetermined time interval, the positioning unit 12 is used to re-position the portable communication apparatus 10 for updating the first location information where the portable communication apparatus 10 is located and receiving the updated second location information sent by the opposite party, so as to update one or a combination of the first location information, the second location information and the relative location information of the first location information and the second location information being displayed on the touch screen 13 (step S410). By using aforesaid updating operation, the portable communication apparatus 10 is capable of providing a more immediate location information to the user to assist the user in tacking the location of the opposite party, so as to locate the opposite party more quickly. In another example, the user may also update the first location information based on demands by, for example, selecting a location updating key, such that the user is able to manually update the current position so as to avoid power consumption caused by an automatic updating.

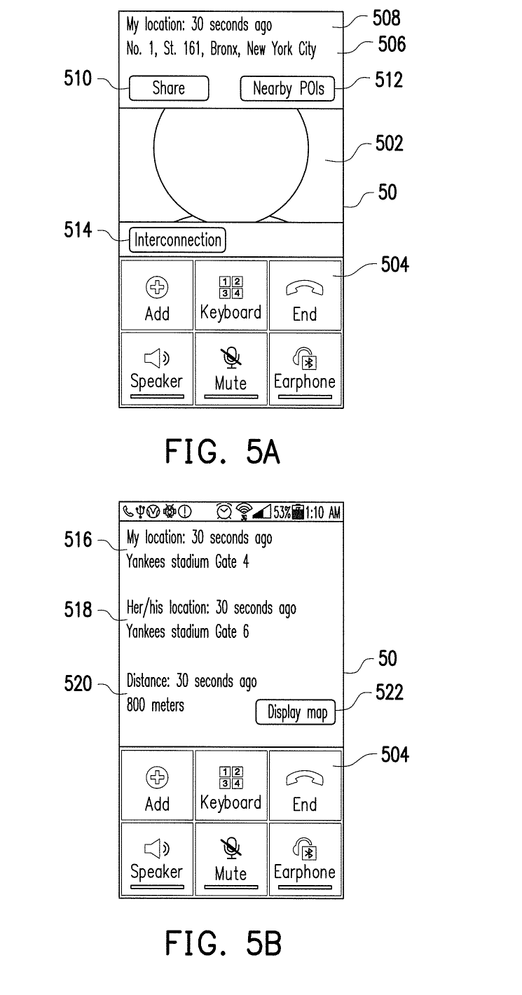

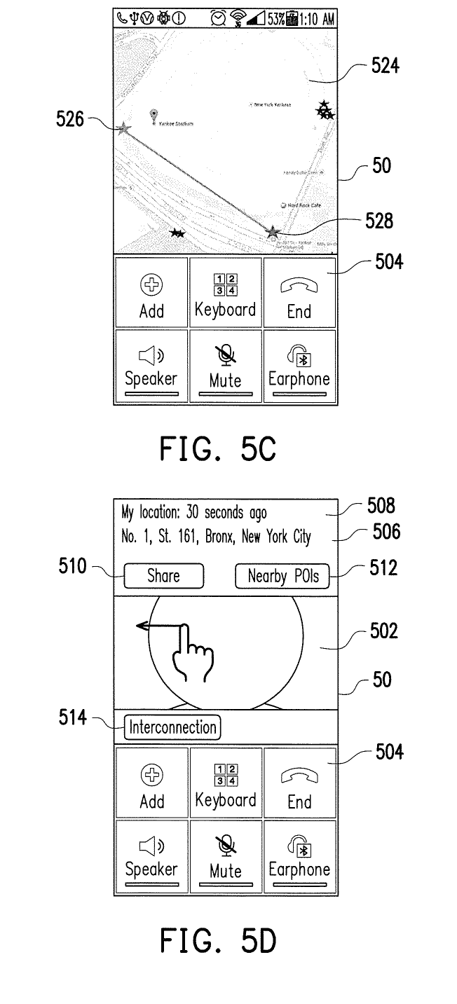

For instance, FIG. 5A to FIG. 5D illustrate an example of the location display method according to an example of the present application. Referring to FIG. 5A, during the call, the portable communication apparatus displays a communication interface 50 on a touch screen thereof. The communication interface 34 may include an image 502 (e.g., a photo) of the opposite party and a plurality of calling function keys 504 (including “add call”, “keyboard”, “end call”, “speaker”, “mute” and “earphone”). The portable communication apparatus obtains location information 506 (e.g., address) where it is currently located and a time 508 elapsed since the positioning, and displays the same on the top of the communication interface 50 for the user to learn his/her latest location. In another example, the portable communication apparatus may also display a time when positioning for obtaining the location information 506 where it is currently located.

In addition, the portable communication apparatus may display, for example, a location sharing key 510, a point of interest key 512 and a location interconnection key 514 in the communication interface 50. The location sharing key 510 is provided for the user to select for sharing the location information 506 of the portable communication apparatus with the opposite party, and has a function identical or similar to that of the location sharing key 348 in the foregoing example, which is not repeated hereinafter. The point of interest key 512 is provided for the user to select for searching the points of interest near the current location of the portable communication apparatus. The location interconnection key 514 is provided for the user to select for receiving the second location information sent by the opposite party, and displaying the first location information 516 of the portable communication apparatus, the second location information 518 of the opposite party and/or a relative location information 520 between the two in the communication interface 50 (as shown in FIG. 5B). In the present example, the first location information 516 and the second location information 518 are displayed in a manner of nearest point of interest (i.e., Yankees stadium gate 4 and gate 6), but the present application is not limited thereto. In other examples, the location information may also be displayed in manners of address or latitude and longitude.

It should be noted that, when the location interconnection key 514 is selected by the user, besides the first location information 516, the second location information 518 and/or the relative location information 520, the portable communication apparatus may also additionally display a map displaying key 522 in the communication interface 50 (as shown in FIG. 5B). The map displaying key 522 is provided for the user to select for converting the first location information 516, the second location information 518 and/or the relative location information 520 into a map format for displaying. When the map displaying key 522 is selected by the user, the portable communication apparatus enters the map displaying mode, so as to display an electronic map 524 nearby the first location information 516 and/or the second location information 518, and mark the first location information 516 and/or the second location information 518 on the electronic map 524 respectively by using icons 526 and 528 (as shown in FIG. 5C).

In addition to above method which enters the map displaying mode by selecting the map displaying key 522, the user may also directly perform a switch operation on the communication interface 50 in order to enter the map displaying mode in the present example. The switch operation may be touch operations such as single touch, multiple touches, double tapping, long press, dragging, pinching, or execution of specific touch or hovering gesture, which are not particularly limited herein. Take FIG. 5D for example, when the user performs an operation of touch and drag to the left on the image 502 in communication interface 50, the portable communication apparatus enters the map displaying mode to display the map as a replacement to the image 502. In an example, when receiving the switch operation performed by the user on the image 502, the portable communication apparatus may determine a manner for displaying the electronic map by, for example, whether the location information of the opposite party is obtained. If the location information of the opposite party is obtained by the user selecting the location sharing key 510, when receiving the switch operation, the portable communication apparatus may display the electronic map with both of the locations in the communication interface 50, or the user may choose to display the electronic map with any one of the locations or both of the locations. If the location sharing key 510 is not selected by the user and the location information of the opposite party is not obtained by the portable communication apparatus, when receiving the switch operation, the portable communication apparatus may only display the electronic map nearby the current location in the communication interface 50.

The present application further provides a non-transitory recording medium in which a computer program is recorded. The computer program is used to execute each step in the location display method as described above. The computer program is composed of a plurality of program code sections (i.e., building an organization diagram program code section, approving a list program code section, setting a program code section, and deploying a program code section). Moreover, after the program code sections are loaded into the portable communication apparatus and executed, the steps in the location display method may be implemented.

In summary, the location display method, the portable communication apparatus using the method and the recording medium using the method according to the present application are capable of displaying the location of the portable communication apparatus in the communication interface, so that the user is able to monitor the current location and inform the same to the opposite party while avoiding the situation of roaming. The present application further provides the keys including location sharing key, location interconnection key, point of interest searching key and map displaying keys for the user to share the location with the opposite party, learn the relative location of both sides, and obtain nearby point of interest information. Accordingly, the user is able to learn and share the location during the call or during the establishment of the call.

Although the present disclosure has been described with reference to the above examples, it is apparent to one of the ordinary skill in the art that modifications to the described examples may be made without departing from the spirit of the present disclosure. Accordingly, the scope of the present disclosure will be defined by the attached claims not by the above detailed descriptions.

What is claimed is:

1. A location display method, adapted for a portable communication apparatus having a positioning unit and a touch screen, the method comprising:
positioning the portable communication apparatus to obtain first location information by using the positioning unit;
displaying a communication interface on the touch screen to proceed a call, wherein the communication interface comprises displaying the first location information.

2. The method according to claim 1, further comprising:
displaying a location sharing key; and
receiving a selecting operation performed on the location sharing key by using the touch screen, and according to contact information of an opposite party of the call, sending the first location information to the opposite party and/or receiving second location information sent by the opposite party.

3. The method according to claim 1, wherein the step of displaying the communication interface on the touch screen to proceed the call further comprises:
detecting whether there is an object nearby by using a sensor;
if detecting that there is the object nearby, disabling a touch function of the touch screen; and
if not detecting that there is the object nearby, activating the touch screen to display communication interface.

4. The method according to claim 1, further comprising:
searching points of interest located near the first location information, and displaying at least one of the points of interest in the communication interface.

5. The method according to claim 1, wherein the step of displaying the communication interface on the touch screen to proceed the call comprises:
displaying a dialing keyboard having a plurality of keys in the communication interface; and
receiving the selection operation performed on the keys by using the touch screen, and searching at least one corresponding contact according to the keys selected by the selection operation and a sequence of the keys selected by the selection operation.

6. The method according to claim 1, further comprising:
receiving the second location information sent by an opposite party of the call, and displaying one or a combination of the second location information and relative location information between the first location information and the second location information in the communication interface.

7. The method according to claim 6, further comprising:
displaying an electronic map in the communication interface, and marking the first location information and the second location information on the electronic map.

8. The method according to claim 1, further comprising:
displaying an image of an opposite party of the call in the communication interface; and
receiving a switch operation performed on the image by using the touch screen, displaying an electronic map around the first location information as a replacement to the image, and marking the first location information on the electronic map.

9. The method according to claim 1, further comprising:
displaying an elapsed time after positioning the portable communication apparatus and obtaining the first location information by the positioning unit in the communication interface.

10. A portable communication apparatus, comprising:
a positioning unit, positioning the portable communication apparatus to obtain first location information;
a wireless communication unit;
a touch screen;
a storage unit, recording a plurality of modules; and
a processing unit, connected to the positioning unit, the touch screen and the storage unit to access and execute the modules recorded in the storage unit, and the modules comprising:
a positioning module, positioning the portable communication apparatus to obtain the first location information by using the positioning unit; and
a call module, displaying a communication interface on the touch screen to proceed a call by using the wireless communication unit, wherein the communication interface comprises displaying the first location information.

11. The portable communication apparatus according to claim 10, wherein the call module further displays a location sharing key in the communication interface, and the modules further comprise:
a location sharing module, in response to a selecting operation performed on the location sharing key received by the touch screen, according to contact information of an opposite party of the call, sending the first location information to the opposite party and/or receiving second location information sent by the opposite party.

12. The portable communication apparatus according to claim 10, further comprising:
a sensor, detecting whether there is an object nearby, wherein
the call module disables a touch function of the touch screen if the sensor detects that there is the object nearby, and the call module activates the touch screen to display the communication interface if the sensor does not detect that there is the object nearby.

13. The portable communication apparatus according to claim 10, wherein the call module further displays a point of interest key in the communication interface, and the modules further comprise:
a point of interest searching module, searching points of interest located near the first location information in response to the selecting operation performed on the point of interest key received by the touch screen, and displaying at least one searched point of interest in the communication interface by the call module.

14. The portable communication apparatus according to claim 10, wherein
the call module further displays a dialing keyboard having a plurality of keys in the communication interface, and in response to the selection operation performed on the keys received by the touch screen, searches at least one corresponding contact according to the keys selected by the selection operation and a sequence of the keys selected by the selection operation.

15. The portable communication apparatus according to claim 10, wherein the call module further displays a location interconnection key in the communication interface, and the modules further comprise:
a location interconnection module, in response to the selecting operation performed on the location interconnection key received by the touch screen, receiving the second location information sent by an opposite party of the call, and displaying one or a combination of the second location information and relative location information between the first location information and the second location information in the communication interface.

16. The portable communication apparatus according to claim 15, wherein the call module further displays a map displaying key in the communication interface, and the modules further comprise:
a map displaying module, in response to the selecting operation performed on the map displaying key received by the touch screen, displaying an electronic map in the communication interface, and marking the first location information and the second location information on the electronic map.

17. The portable communication apparatus according to claim 15, wherein the location interconnection module further re-positions the portable communication apparatus by using the positioning unit per a time interval to update the first location information where the portable communication apparatus is located, and receives the updated second location information sent by the opposite party thereby updating one or a combination of the displayed first location information, the displayed second location information and the relative location information of the displayed first location information and the displayed second location information.

18. The portable communication apparatus according to claim 10, wherein the call module further displays an image of the opposite party of the call in the communication interface, and the modules further comprise:
a map displaying module, in response to a switch operation performed on the image received by the touch screen, displaying an electronic map around the first location information as a replacement to the image, and marking the first location information on the electronic map.

19. The portable communication apparatus according to claim 10, wherein the call module further displays an elapsed time after positioning the portable communication apparatus and obtaining the first location information by the positioning unit in the communication interface.

20. A non-transitory recording medium for recording a program to be loaded by a portable communication apparatus to execute steps of:
positioning the portable communication apparatus to obtain first location information by using a positioning unit of the portable communication apparatus; and
displaying a communication interface on a touch screen of the portable communication electronic apparatus to proceed a call, wherein the communication interface comprises displaying the first location information.
